(19) United States
(12) Patent Application Publication
(10) Pub. No.: US 2007/0120767 A1
(43) Pub. Date: May 31, 2007

(54) Plasma display apparatus

(76) Inventors: Muk Hee Kim, Daegu-si (KR); Yun Kwon Jung, Kumi-si (KR); Byung Hyun Kim, Kumi-si (KR)

Correspondence Address: KED & ASSOCIATES, LLP, P.O. Box 221200, Chantilly, VA, 20153-1200, US

(21) Appl. No.: 11/346,625

(22) Filed: Feb. 3, 2006

(30) Foreign Application Priority Data
Nov. 28, 2005 (KR) 10-2005-0114285

(51) Int. Cl. G09G 3/28

(52) U.S. Cl. 345/60

(57) ABSTRACT

A plasma display apparatus is provided. The apparatus includes a first cell provided inside a window having a percentage of “a” or more of an on-cell turned on during one frame; and a second cell provided inside a window having a percentage of less than “a” of the on-cell turned on during one frame, wherein more sustain waveforms are applied to the second cell than the first cell.

### BACKGROUND OF THE INVENTION

1. Field of the Invention

The present invention relates to a plasma display apparatus, and more particularly, to a plasma display apparatus for embodying a darkroom contrast differently depending on a size of a window for displaying an image.

2. Description of the Background Art

Plasma display apparatus refers to an apparatus in which discharge cells are formed between a rear substrate having a barrier rib and a front substrate facing the rear substrate, and an image is embodied by exciting a phosphor using vacuum ultraviolet rays that are generated when inert gas within each discharge cell is discharged by a high frequency voltage.

FIG. 1 is a perspective view illustrating a discharge cell of a conventional plasma display apparatus, and FIG. 2 is a sectional view illustrating the discharge cell of the conventional plasma display apparatus.

First, the discharge cells are provided on a rear substrate 18 facing a front substrate 10, using a plurality of barrier ribs 24 partitioning a discharge space.

An address electrode (X) is formed on the rear substrate 18, and a scan electrode (Y) and a sustain electrode (Z) are provided in pair on the front substrate 10. The address electrode (X) intersects with other electrodes (Y and Z), and the rear substrate 18 of FIG. 2 is shown with rotated at an angle of 90°.

A lower dielectric layer 22 for accumulating wall charges is formed on the rear substrate 18 including the address electrode (X).

The barrier rib 24 is formed on the lower dielectric layer 22, thereby providing the discharge space between the barrier ribs, and preventing ultraviolet rays and visible rays generated in discharge from leaking into a neighboring discharge cell. A phosphor 26 is coated on surfaces of the dielectric layer 22 and the barrier rib 24.

Since the inert gas is injected into the discharge space, the phosphor 26 is excited using the ultraviolet rays generated in the gas discharge, thereby emitting any one of red, green and blue.

The scan electrode (Y) and the sustain electrode (Z) formed on the front substrate 10 are comprised of transparent electrodes (12Y and 12Z) and bus electrodes (13Y and 13Z), and intersect with the address electrode (X). An upper dielectric layer 14 and a protective film 16 are formed to cover the scan electrode (Y) and the sustain electrode (Z).

After the above-constructed discharge cell is selected by an opposite discharge generated between the address electrode (X) and the scan electrode (Y), the discharge is sustained by a surface discharge generated between the scan electrode (Y) and the sustain electrode (Z), thereby emitting the visible rays.

The scan electrode (Y) and the sustain electrode (Z) each are comprised of the transparent electrodes (12Y and 12Z), and the bus electrodes (13Y and 13Z) having smaller widths than the transparent electrodes and formed at one sides and edges of the transparent electrodes.

FIG. 3 illustrates one frame of the conventional plasma display apparatus.

Referring to FIG. 3, in order to embody a gray level of the image, the plasma display apparatus is time-division driven with one frame divided into several subfields having a different number of times of emission. Each of the subfields (SF1 to SF8) is divided into a reset period for initializing wall charges within the discharge cell, an address period for selecting a scan line and selecting the discharge cell from the selected scan line, and a sustain period for embodying the gray level depending on the number of times of discharge.

The gray level expressed at the subfield constituted of the reset period, the address period, and the sustain period is accumulated during one frame. When the image is displayed at a 256 gray level, a frame period (16.67 ms) corresponding to 1/60 seconds is divided into eight subfields (SF1 to SF8), and a gray level of 2ⁿ (n=0, 1, 2, 3, 4, 5, 6, 7) is expressed at each subfield.

In particular, when the conventional plasma display apparatus expresses the gray level as in the above-described method, a driver is controlled through a controller so that the gray level of the same value is expressed irrespective of a size of a window for displaying the image. An example thereof will be described with reference to FIG. 4.

Referring to FIG. 4A, in case where a relatively bright image (P) is displayed within a small window (W_S), it is more reduced in size and displayed than when the bright image (P) is displayed within a broad window (W_B). Accordingly, there is a drawback in that, even when the images are displayed within both small and broad windows at the same gray level, the image within the small window is caught in eyesight to be darker than the image within the broad window.

Similarly, referring to FIG. 4B, even in case where a relatively dark image (P′) is displayed at the same gray level, though the image within the small window (W_S) has a rough contour or boundary, the rough contour or boundary is not greatly caught in eyesight whereas, there is a drawback in that, if the image within the broad window (W_B) has the rough contour or boundary, blurring color and unclear boundary are easily caught in eyesight.

### SUMMARY OF THE INVENTION

Accordingly, an object of the present invention is to solve at least the problems and disadvantages of the background art.

An object of the present invention is to provide a plasma display apparatus for embodying a darkroom contrast differently depending on a size of a window for displaying an image.

To achieve these and other advantages and in accordance with the purpose of the present invention, as embodied and broadly described, there is provided a plasma display apparatus including: a first cell provided inside a window having a percentage of “a” or more of an on-cell turned on during one frame; and a second cell provided inside a window having a percentage of less than “a” of the on-cell turned on during one frame, wherein more sustain waveforms are applied to the second cell than the first cell.

The percentage of “a” of the on-cell may be 1% to 4%, and a greater number of sustain waveforms are applied by 20% to 30% to the second cell than the first cell, or number of subfields within one frame is increased in the second cell in comparison with the first cell.

In the first cell provided inside the window having the percentage of “a” or more of the on-cell turned on during one frame, and a third cell provided outside the window, a reset waveform and a pre reset waveform before the reset waveform are applied for cell initialization during at least one subfield, thereby increasing an efficiency of discharge.

In the second cell provided inside the window having the percentage of less than “a” of the on-cell turned on during one frame, and a fourth cell provided outside the window, the reset waveform is applied without the pre reset waveform during at least one subfield, thereby cutting off light emission caused by the pre reset discharge.

The reset waveform continuously ramps-up with at least two steps from a bias voltage level to a setup voltage and then, ramps-down with at least two steps up to a base voltage.

The pre reset waveform continuously ramps-down from a bias voltage level to a base voltage and then, ramps-up from the base voltage to the bias voltage level.

In other words, during the reset period of at least one subfield constituting one frame, the first reset waveform having a voltage for generating the first reset discharge, and the second reset waveform having a higher voltage than the first reset waveform and generating the second reset discharge are applied to the first cell provided inside the window having the percentage of “a” or more of the on-cell turned on during one frame. During the reset period of at least one subfield constituting one frame, only the second reset waveform is generated in the second cell provided inside the window having the percentage of less than “a” of the on-cell turned on during one frame.

### BRIEF DESCRIPTION OF THE DRAWINGS

The invention will be described in detail with reference to the following drawings in which like numerals refer to like elements.

FIG. 1 is a perspective view illustrating a discharge cell of a conventional plasma display apparatus;

FIG. 2 is a sectional view illustrating a discharge cell of a conventional plasma display apparatus;

FIG. 3 illustrates a construction of a frame for embodying a 256 gray level;

FIG. 4 illustrates an example of expressing an image gray level depending on a window size in a conventional plasma display apparatus;

FIG. 5 illustrates an example of expressing an image gray level depending on a window size in a plasma display apparatus according to an embodiment of the present invention;

FIG. 6 is a driving waveform diagram for displaying an image within a broad window in a plasma display apparatus according to the first embodiment of the present invention;

FIG. 7 is a driving waveform diagram for displaying an image within a small window in a plasma display apparatus according to the first embodiment of the present invention;

FIG. 8 is a driving waveform diagram for displaying an image within a broad window in a plasma display apparatus according to the second embodiment of the present invention; and

FIG. 9 is a driving waveform diagram for displaying an image within a small window in a plasma display apparatus according to the second embodiment of the present invention.

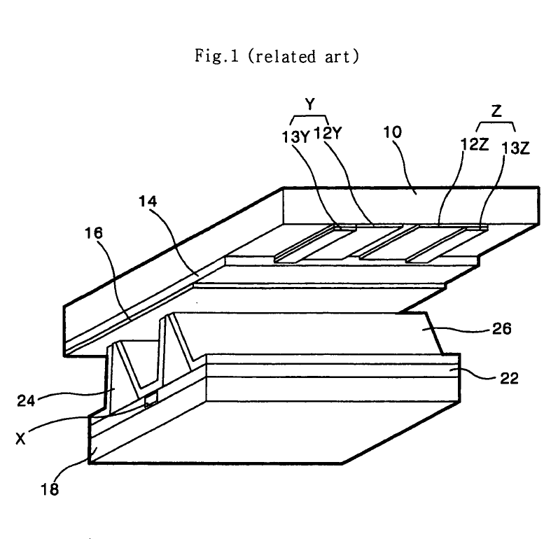

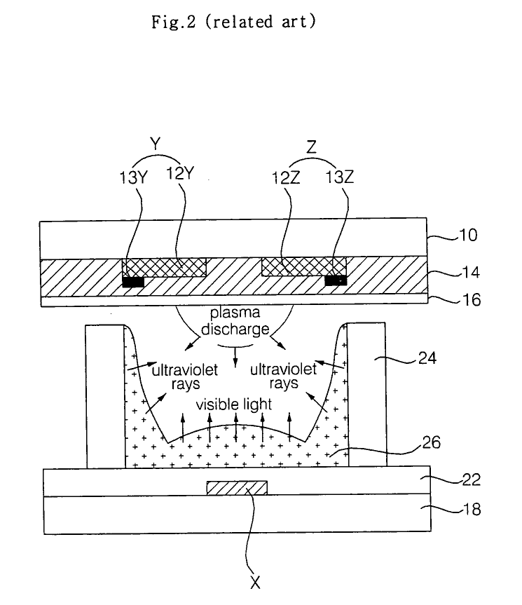

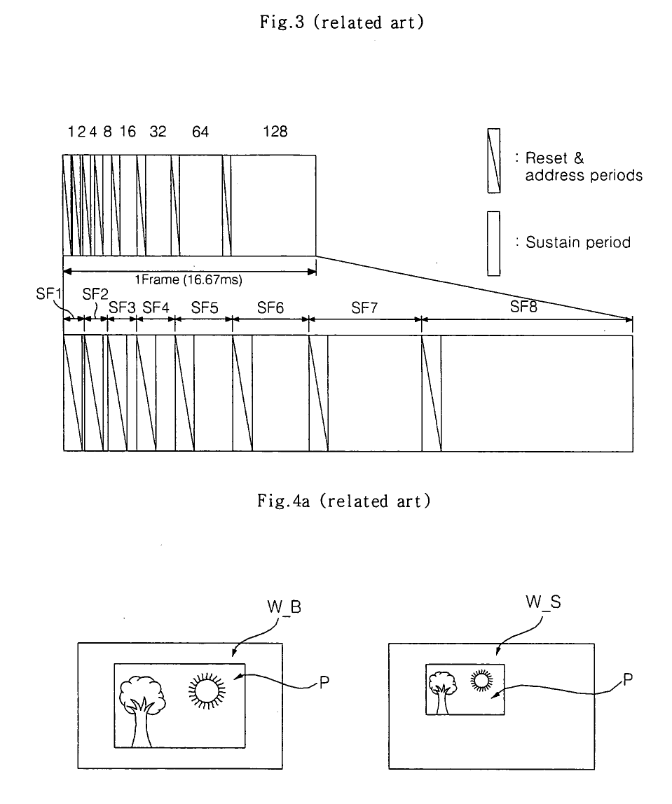

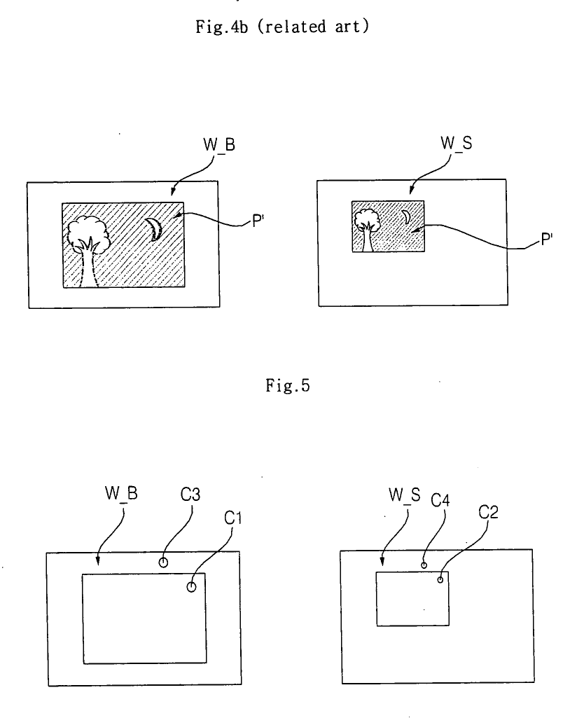

### DETAILED DESCRIPTION OF PREFERRED EMBODIMENTS

Preferred embodiments of the present invention will be described in a more detailed manner with reference to the drawings.

First, a window shown at the left of FIG. 5 refers to a window (W_B) having a percentage of “a” or more of an on-cell turned on during one frame. A discharge cell positioned inside the window is called “first cell (C1)”, and a discharge cell positioned outside the window is called “third cell (C3)”.

Similarly, a window shown at the right of FIG. 5 refers to a window (W_S) having a percentage of less than “a” of the on-cell turned on during one frame. A discharge cell positioned inside the window is called “second cell (C2)”, and a discharge cell positioned outside the window is called “fourth cell (C4)”.

The percentage “a” of the on-cell is 1% to 4% of a total discharge cell. The window (W_B) having the percentage of “a” or more is called “broad window”, and the window (W_S) having the percentage of less than “a” is called “small window”.

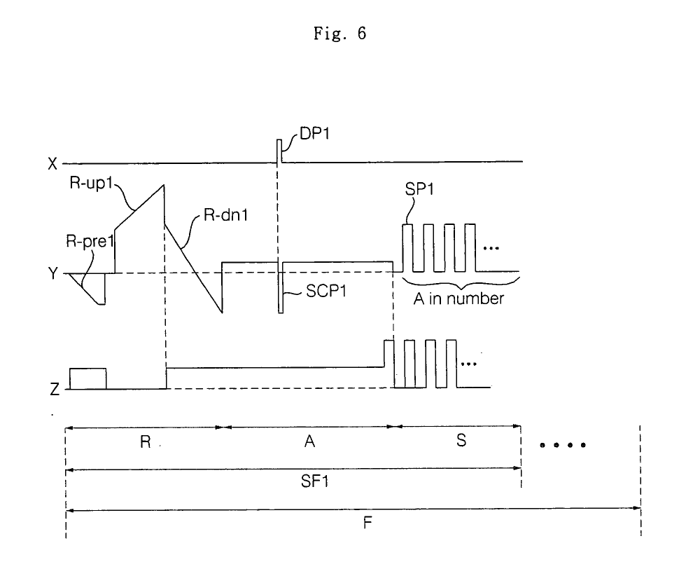

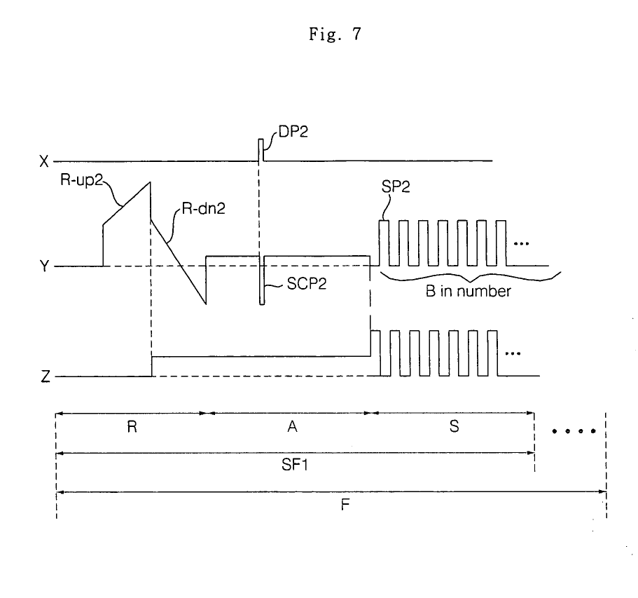

FIG. 6 is a diagram illustrating a driving waveform supplied when the window (W_B) has the percentage of “a” or more of the on-cell according to the first embodiment of the present invention, and FIG. 7 is a diagram illustrating a driving waveform supplied when the window (W_S) has the percentage of less than “a” of the on-cell according to the first embodiment of the present invention.

FIGS. 6 and 7 illustrate at least one subfield (SF1) constituting one frame (F). The subfield is constituted of at least one of a reset period (R), an address period (A), and a sustain period (S).

Referring to FIG. 6, during the reset period (R), a pre reset waveform (R_pre1) and a reset waveform constituted of a setup waveform (R_up1) and a setdown waveform (R_dn1) are applied to a scan electrode (Y).

The pre reset waveform (R_pre1) continuously ramps-down from a bias voltage level to a negative voltage level and then, ramps-up up to the bias voltage level. The negative voltage level can be set to be the same as or different from a bottom voltage level of the setdown waveform (R_dn1).

While the pre reset waveform (R_pre1) is applied to the scan electrode (Y), a positive bias voltage is applied to a sustain electrode (Z). Accordingly, positive wall charges are formed on the scan electrode (Y) and an address electrode (X), and negative wall charges are formed on the sustain electrode (Z).

As such, the pre reset waveform (R_pre1) is applied to smoothly perform initialization of the discharge cell using a weak first reset discharge and therefore, it is not required to apply the pre reset waveform (R_pre1) for all subfields constituting one frame.

Accordingly, before the reset waveform, the pre reset waveform (P_pre1) can be applied at each subfield (SF), or can be applied only during about one or three initial subfields constituting one frame, thereby generating priming particles.

After the pre reset waveform (R_pre1) is applied, the setup waveform (R_up1) is applied, thereby storing the wall charges within the discharge cell, the setdown waveform (R_dn1) ramping-down up to a specific negative voltage level is applied, thereby erasing some excessive wall charges from the discharge cell.

In other words, during the reset period (R), the first reset discharge (weak discharge) is generated by the pre reset waveform (R_pre1), and a second reset discharge (strong discharge) stronger than the first reset discharge is generated by a second reset waveform having a higher voltage than the pre reset waveform.

During the address period (A), a scan pulse (SCP1) sustaining a scan bias voltage and falling to the negative voltage level is applied. At this time, a data pulse (DP1) rising to a positive voltage level in synchronization with the scan pulse (SCP1) is applied to the address electrode (X). By a voltage difference between the scan pulse (SCP1) applied to the scan electrode (Y) and the data pulse (DP1) applied to the address electrode (X), an address discharge is generated.

During the sustain period (S), a sustain pulse (SP1) having a sustain voltage level is alternately applied to the scan electrode (Y) and the sustain electrode (Z), thereby generating a sustain discharge. At this time, it is assumed that number of the sustain pulses applied during the sustain period (S) is denoted by A.

In FIG. 7, the waveform applied during the reset period (R) and the number of the sustain pulses applied during the sustain period (S) are different from and other waveforms are the same as those of FIG. 6. Therefore, their duplicate descriptions will be omitted.

Referring to FIG. 7, during the reset period (R), a reset waveform constituted of a ramp-up type setup waveform (R_up2) and a ramp-down type setdown waveform (R_dn2) is applied to the scan electrode (Y), and the pre reset waveform (R_pre1) is not applied as in FIG. 6. Therefore, when the image is displayed within the window having the percentage of less than “a” of the on-cell, light emitted at the time of the weak discharge generated by the pre reset waveform is cut off, thereby causing the image to be displayed with more darkness.

In other words, in the first cell (C1) provided inside the window (W_B) having the percentage of “a” or more of the on-cell turned on during one frame, and the third cell (C3) provided outside the window (W_B), the reset waveform and the pre reset waveform before the reset waveform are applied during the reset period (R) of at least one subfield, thereby improving an efficiency of discharge. In the second cell (C2) provided inside the window (W_S) having the percentage of less than “a” of the on-cell turned on during one frame, and the fourth cell (C4) provided outside the window (W_S), only the reset waveform is applied during the reset period (R) of at least one subfield without the pre reset waveform.

When the on-cell has the percentage of less than “a”, the driven discharge cells are less in number and therefore, even though the initialization of discharge cell generated by the pre reset waveform (R_pre1) is not performed, the driving efficiency is not greatly influenced. Since the pre reset waveform is omitted, the light can be prevented from being emitted and deteriorating a picture quality of a dark image.

The number (B) of the sustain pulses applied during the sustain period (S) of FIG. 7 is a number increasing as much as 20% to 30% of the number (A) of the pulses of FIG. 6. Accordingly, even when the same image is displayed, the image is displayed with more brightness within the window (W_S) having the percentage of less than “a” of the on-cell. Therefore, a satisfaction for the picture quality caught in eyesight increases.

In addition, in order to brightly display the image within the window (W_S) having the percentage of less than “a” of the on-cell, the subfield (SF) constituting one frame shown in FIG. 7 is greater in number than the subfield constituting one frame shown in FIG. 6.

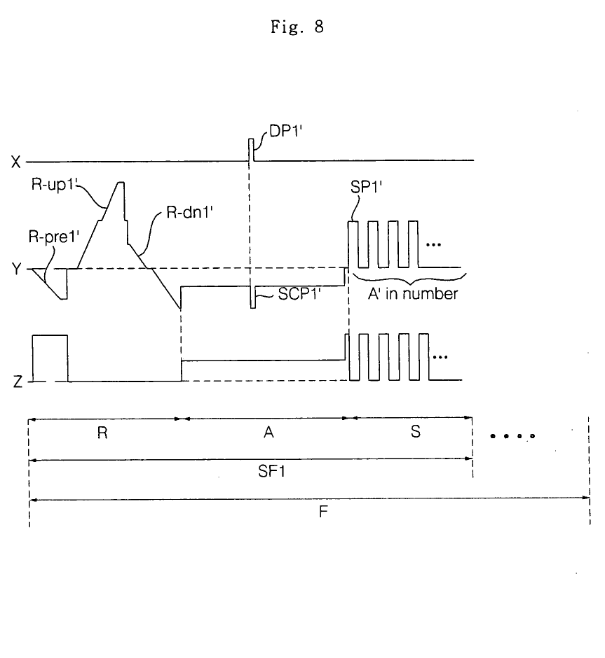

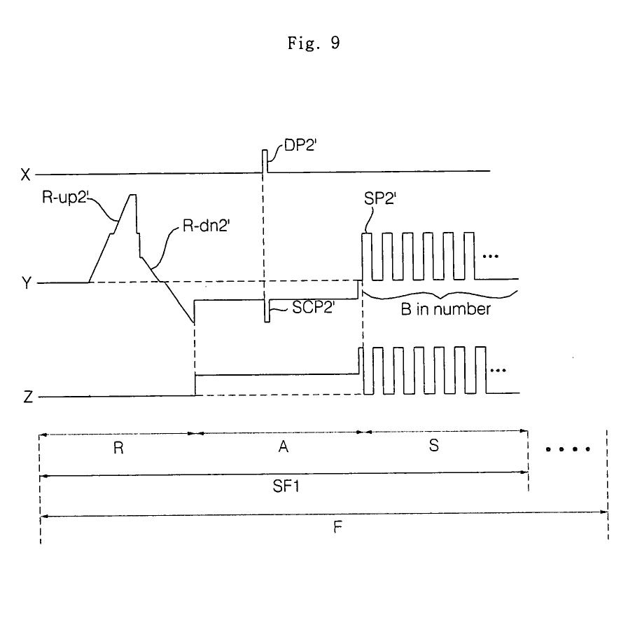

FIG. 8 is a diagram illustrating a driving waveform supplied when a window (W_B) has a percentage of “a” or more of an on-cell according to the second embodiment of the present invention, and FIG. 9 is a diagram illustrating a driving waveform supplied when a window (W_S) has a percentage of less than “a” of the on-cell according to the second embodiment of the present invention.

The driving waveforms according to the second embodiment are different from those of the first embodiment of FIGS. 6 and 7 in that setup waveforms (R_up1′ and R_up2′) ramping-up with two or more steps and setdown waveforms (R_dn1′ and R_dn2′) ramping-down with two or more steps are applied during a reset period (R).

Referring to FIG. 8, during the reset period (R), a pre reset waveform (R_pre1′) generating a first reset discharge, and a reset waveform constituted of a setup waveform (R_up1′) and a setdown waveform (R_dn1′) and generating a second reset discharge are applied to a scan electrode (Y) during the reset period (R).

The pre reset waveform (R_pre1′) is the same as the pre reset waveform (R_pre1) according to the first embodiment of the present invention and therefore, its description will be omitted.

The setup waveform (R_up 1′) ramping-up with at least two steps ramps-up along a first slope up to a sustain voltage, and ramps-up along a second slope from the sustain voltage to a setup voltage. The first slope is greater than the second slope.

The setdown waveform (R_dn1′) ramping-down with at least two steps ramps-down up to the sustain voltage, and is sustained at the sustain voltage for a predetermined time and then, ramps-down from the sustain voltage to a ground level. Subsequently, it ramps-down up to a negative voltage level.

As the reset waveform constituted of the setup waveform (R_up1′) and the setdown waveform (R_dn1′) is applied to the scan electrode (Y), the reset discharge is generated. Therefore, wall charges are erased from the scan electrode (Y) and a sustain electrode (Z) so that an amount of the wall charges suitable to the address discharge exist within the discharge cell.

During the sustain period (S), a sustain pulse (SP1′) having the sustain voltage level is alternately applied to the scan electrode (Y) and the sustain electrode (Z), thereby generating a sustain discharge. At this time, it is assumed that number of the sustain pulses applied during the sustain period (S) is denoted as A′.

Referring to FIG. 9, the waveform applied during the reset period (R) and the number (B′) of the sustain pulses applied during the sustain period (S) are different, and other waveforms are the same and therefore, their duplicate descriptions will be omitted.

Referring to FIG. 9, during the reset period (R), a reset waveform constituted of a setup waveform (R_up2′) and a setdown waveform (R_dn2′) is applied to the scan electrode (Y), and the pre reset waveform (R_pre1′) is not applied as in FIG. 8. Therefore, when the image is displayed within the window having the percentage of less than “a” of the on-cell, light emitted at the time of the weak discharge generated by the pre reset waveform is cut off, thereby causing the image to be displayed with more darkness.

In other words, when the on-cell has the percentage of less than “a”, the driven discharge cells are less in number and therefore, even though the initialization of discharge cell generated by the pre reset waveform (R_pre1′) is not performed, the driving efficiency is not greatly influenced. The pre reset waveform is omitted and therefore, the light can be prevented from being emitted and deteriorating a picture quality of a dark image.

The number (B′) of the sustain pulses applied during the sustain period (S) of FIG. 9 is a number increasing as much as 20% to 30% of the number (A′) of the pulses of FIG. 8. Accordingly, even when the same image is displayed, the image is displayed with more brightness within the window having the percentage of less than “a” of the on-cell. Therefore, a satisfaction for the picture quality caught in eyesight increases.

In addition, in order to brightly display the image within the window having the percentage of less than “a” of the on-cell, the subfield constituting one frame shown in FIG. 9 is greater in number than the subfield constituting one frame shown in FIG. 8.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a first cell provided inside a window having a percentage of “a” or more of an on-cell turned on during one frame; and
a second cell provided inside a window having a percentage of less than “a” of the on-cell turned on during one frame,
wherein more sustain waveforms are applied to the second cell than the first cell.

2. The apparatus of claim 1, wherein the percentage of “a” of the on-cell is 1% to 4%.

3. The apparatus of claim 1, wherein a greater number of sustain waveforms are applied by 20% to 30% to the second cell than the first cell.

4. The apparatus of claim 1, wherein number of subfields within one frame is increased in the second cell in comparison with the first cell.

5. The apparatus of claim 1, wherein in the first cell provided inside the window having the percentage of “a” or more of the on-cell turned on during one frame, and a third cell provided outside the window, a reset waveform and a pre reset waveform before the reset waveform are applied for cell initialization during at least one subfield.

6. The apparatus of claim 5, wherein the reset waveform continuously ramps-up from a bias voltage level to a setup voltage and then, ramps-down up to a base voltage.

7. The apparatus of claim 5, wherein the reset waveform ramps-up with at least two steps from a bias voltage level to a setup voltage.

8. The apparatus of claim 5, wherein the reset waveform ramps-up along a first slope up to a sustain voltage, and ramps-up along a second slope from the sustain voltage to a setup voltage.

9. The apparatus of claim 8, wherein the second slope is less than the first slope.

10. The apparatus of claim 5, wherein the reset waveform ramps-down with at least two steps from a setup voltage to a base voltage.

11. The apparatus of claim 5, wherein the reset waveform ramps-down up to a sustain voltage and then, ramps-down from the sustain voltage to a base voltage.

12. The apparatus of claim 5, wherein the pre reset waveform continuously ramps-down from a bias voltage level to a base voltage and then, ramps-up from the base voltage to the bias voltage level.

13. The apparatus of claim 5, wherein in the second cell provided inside the window having the percentage of less than “a” of the on-cell turned on during one frame, and a fourth cell provided outside the window, the reset waveform is applied without the pre reset waveform during at least one subfield.

14. A plasma display apparatus comprising:
a first cell provided inside a window having a percentage of “a” or more of an on-cell turned on during one frame; and
a second cell provided inside a window having a percentage of less than “a” of the on-cell turned on during one frame,
wherein during a reset period of an initial subfield constituting one frame, a first reset waveform having a voltage for generating a first reset discharge, and a second reset waveform having a higher voltage than the first reset waveform and generating a second reset discharge are applied to the first cell.

15. The apparatus of claim 14, wherein the first reset waveform continuously ramps-down from a bias voltage level to a base voltage and then, ramps-up up to the bias voltage level, and
the second reset waveform continuously ramps-up from the bias voltage level to a setup voltage and then, ramps-down up to the base voltage.

16. The apparatus of claim 14, wherein during the reset period of the initial subfield constituting one frame, only the second reset waveform is applied to the second cell.

17. The apparatus of claim 14, wherein the percentage of “a” of the window is 1% to 4%.

18. A plasma display apparatus comprising:
a first cell provided inside a window having a percentage of “a” or more of an on-cell turned on during one frame; and
a second cell provided inside a window having a percentage of less than “a” of the on-cell turned on during one frame,
wherein the second cell has a greater number of subfields within one frame than the first cell.

19. The apparatus of claim 18, wherein the percentage of “a” of the window is 1% to 4%.

20. The apparatus of claim 18, wherein during the reset period of the subfield, a first reset waveform having a voltage for generating a first reset discharge, and a second reset waveform having a higher voltage than the first reset waveform and generating a second reset discharge are applied to the first cell, and
wherein only the second reset waveform is applied to the second cell.
